(19) United States
(12) Patent Application Publication
(10) Pub. No.: US 2011/0237111 A1
(43) Pub. Date: Sep. 29, 2011

(54) ELECTRICAL CONNECTOR ASSEMBLY HAVING IMPROVED PROTECTING MEANS

(75) Inventors: Su-Feng LIU, Kunshan (CN); Chin-Te LAI, New Taipei (TW); Bin XU, Kunshan (CN)

(73) Assignee: HON HAI PRECISION INDUSTRY CO., LTD., New Taipei (TW)

(21) Appl. No.: 13/072,825

(22) Filed: Mar. 28, 2011

(30) Foreign Application Priority Data
Mar. 26, 2010 (CN) 201010133511.2

(51) Int. Cl. H01R 13/62

(52) U.S. Cl. 439/354

(57) ABSTRACT

An electrical connector assembly (100) for mating with a complementary connector and connecting with a cable includes an electrical connector (2) and a protecting means (4). The electrical connector includes an insulative housing (20) formed with a latch (206), and a number of contact terminals (22) mounted in the insulative housing. The protecting means partially accommodates the insulative housing and is formed with a resilient beam (440). The latch of the electrical connector is disposed beneath the resilient beam. The protecting means is formed with a blocking portion (424), and the insulative housing defines a notch (204). The blocking portion is confined in the notch.

### BACKGROUND OF THE INVENTION

1. Field of the Invention

The present invention relates to an electrical connector assembly, and more particularly to a modular jack connector assembly having a modular jack plug and a protecting means protecting the modular jack plug.

2. Description of Related Art

U.S. Pat. No. 5,462,457 issued on Oct. 31, 1995 discloses an electrical connector assembly comprising a modular jack plug connecting with a cable. The modular jack plug comprises a housing, a latch formed on the housing for latching with a mating connector, and a protecting means adhered to the housing for protecting the latch.

The unitary overmold comprises a manually acturable dome-shaped pocket for resiliently deflecting the latch.

An electrical connector assembly having an improved protecting means is desired.

### SUMMARY OF THE INVENTION

Accordingly, an object of the present invention is to provide an electrical connector assembly including a protecting means latching with an insulative housing reliably via an engagement between a blocking portion and a notch.

In order to achieve the object set forth, an electrical connector assembly for mating with a complementary connector and connecting with a cable includes an electrical connector and a protecting means. The electrical connector includes an insulative housing formed with a latch, and a number of contact terminals mounted in the insulative housing. The protecting means partially accommodates the insulative housing and is formed with a resilient beam. The latch of the electrical connector is disposed beneath the resilient beam. The protecting means is formed with a blocking portion, and the insulative housing defines a notch. The blocking portion is confined in the notch.

The blocking portion is confined in the notch. The blocking portion is devoid of having a movement along a direction perpendicular to the front-to-back direction. No matter the protecting means is made of any material, the protecting means would latch with the insulative housing reliably due to the engagement between the blocking portion and the notch.

Other objects, advantages and novel features of the invention will become more apparent from the following detailed description when taken in conjunction with the accompanying drawings.

### BRIEF DESCRIPTION OF THE DRAWINGS

FIG. 1 is an assembled perspective view showing an electrical connector assembly in accordance with the present invention;

FIG. 2 is an another assembled perspective view similar to FIG. 1, taken from another aspect;

FIG. 3 is a partially exploded view showing an electrical connector and a protecting means as shown in FIG. 1;

FIG. 4 is another partially exploded view similar to FIG. 3, taken from another aspect;

FIG. 5 is a cross-sectional view of the electrical connector assembly, taken along line 5-5 of FIG. 1, when the protecting means is positioned in a first position; and

FIG. 6 is view similar to FIG. 5, when the protecting means is positioned in a second position.

### DETAILED DESCRIPTION OF THE PREFERRED EMBODIMENT

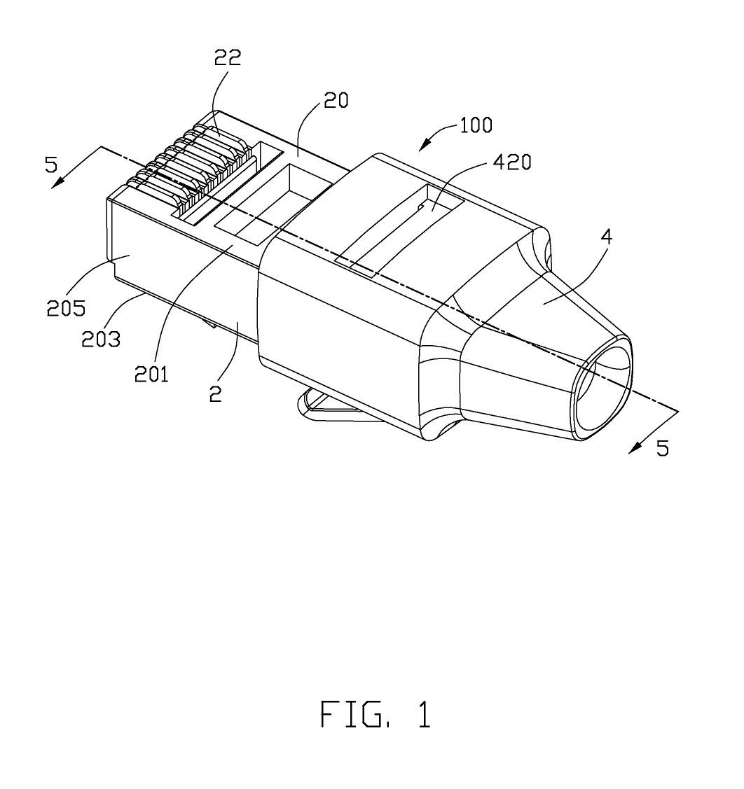

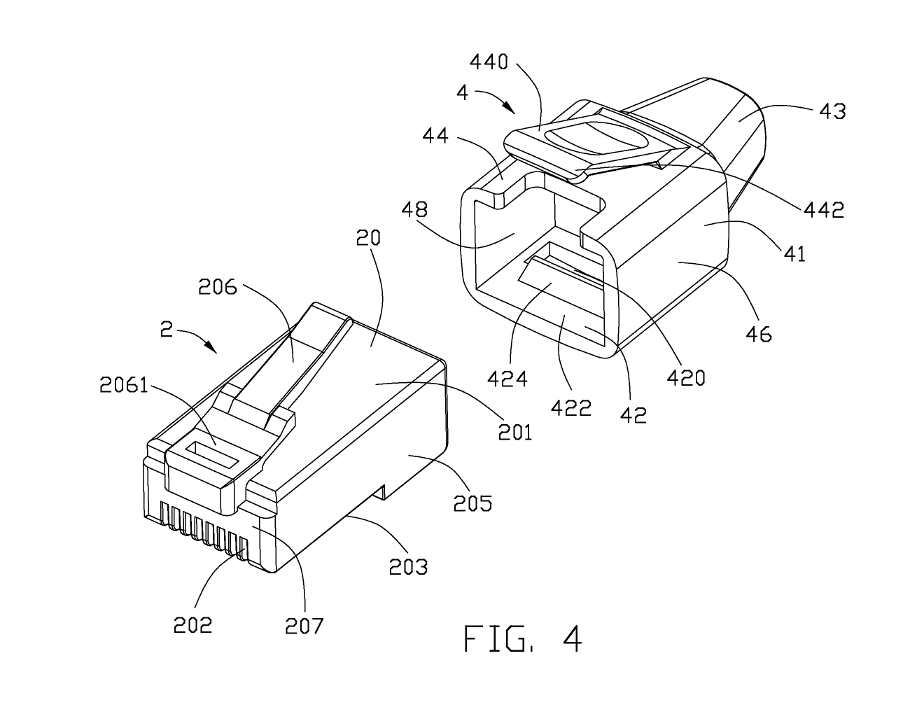

Reference will now be made in detail to the preferred embodiment of the present invention. Referring to FIGS. 1-6, an electrical connector assembly 100 comprises an electrical connector 2, i.e., a modular jack plug in this embodiment, and a protecting means 4 partially accommodating the electrical connector 2.

The electrical connector 2 comprises an insulative housing 20 and a plurality of contact terminals 22 assembled to the insulative housing 20. The insulative housing 20 includes a front face 207, a bottom face 203, and a pair of periphery faces 205. The insulative housing 205 is formed into a stepped configuration and has a top face 208, an upper face 201 lower than the top face 208, and a cavity 209 surrounded by the top face 208, the upper face 201, the bottom face 203 and a pair of periphery faces 205. The insulative housing 20 has a plurality of passageways 202 extending through the front face 207, and a notch 204 recessed from the top face 208. The insulative housing 20 has a latch 206 engaging with a complementary receptacle connector (not shown). The latch 206 includes a connecting portion 2061 integrating with the insulative housing 20 and tilts obliquely from the bottom face 203.

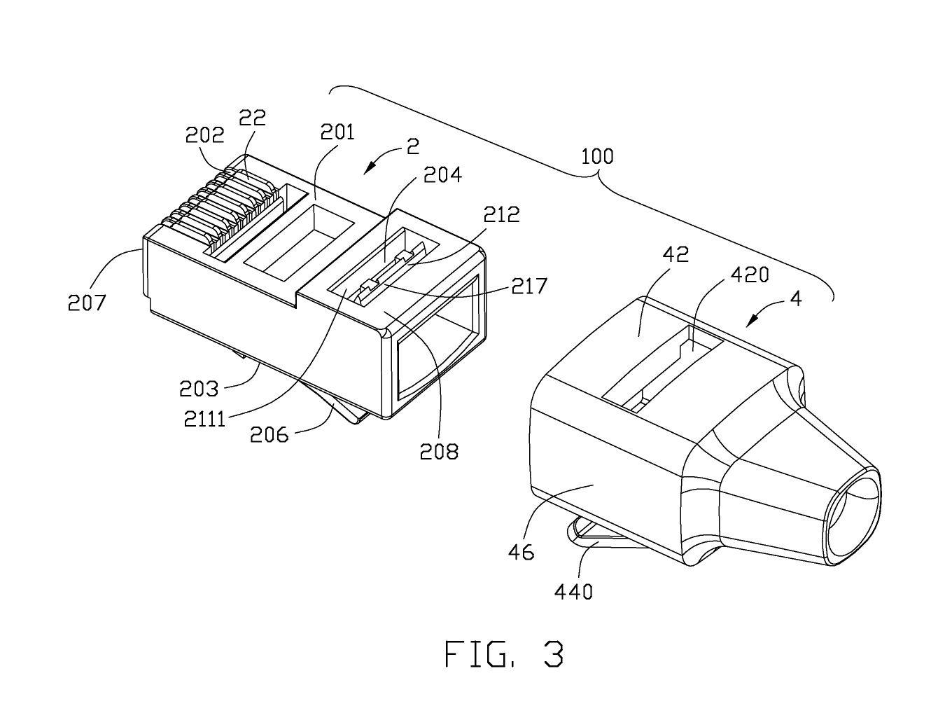

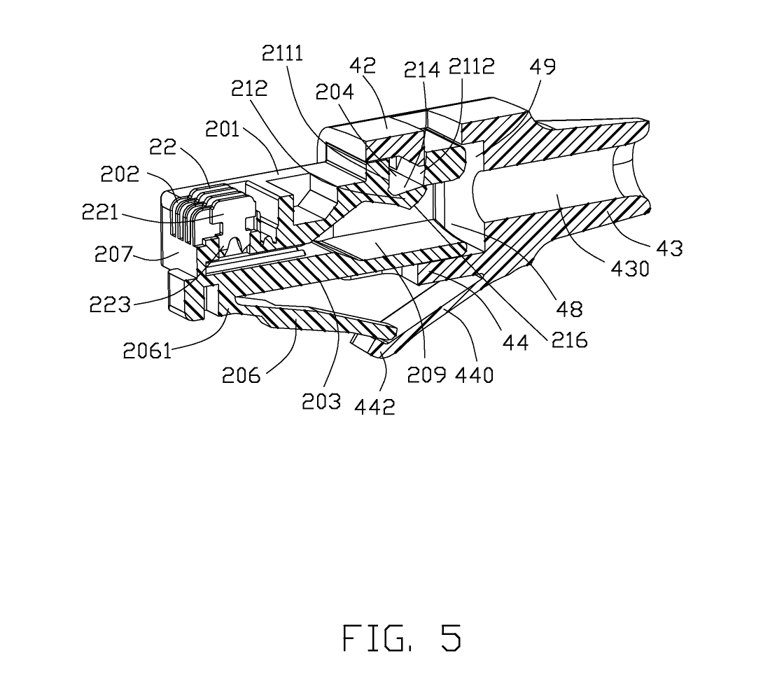

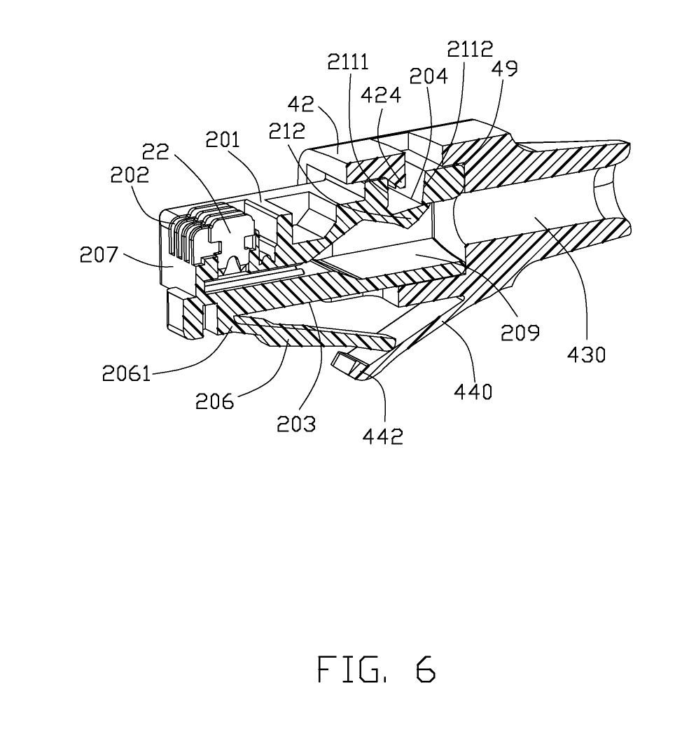

Referring to FIGS. 3, 5 and 6, the notch 204 has a front and a rear faces 2111, 2112 parallel to the front face 207, and a retention portion 212 formed in the notch 204. The retention portion 212 has obliquely extending first and second faces 214, 216. Referring to FIG. 3, the retention portion 212 stands upwardly between the front and rear faces 2111, 2112 before using. The second face 216 of the retention portion 212 and the rear face 2112 of the notch 204 has a slit 217 therebetween for easing deformation of the retention portion 212. Referring to FIGS. 5 and 6, the retention portion 212 is bent away from the notch 204 to the cavity 209 for depressing an inserted cable (not shown).

In conjunction with FIG. 5-6, each contact terminal 22 includes a contact portion 221 for mating with the complementary connector, and a pair of teeth 223 extending from the contact portion 221 for puncturing the wires of the inserted cable and connecting the cable to the complementary connector.

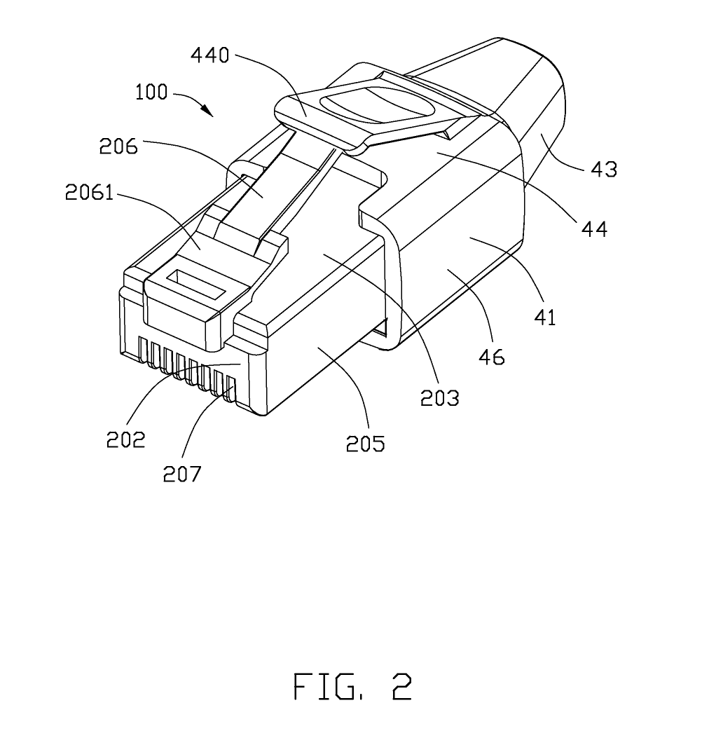

Referring to FIGS. 2-6, the protecting means 4 comprises a cap portion 41 partially enclosing the insulative housing 20, and a tail portion 43 defining a hole 430 for receiving the cable. The cap portion 41 has an upper wall 42, a bottom wall 44, a pair of middle walls 46, and a receiving space 48 defined therebetween. The receiving space 48 has a shoulder portion 49 defined therein and adjacent to the hole 430. The upper wall 42 has an inner face 422, and a blocking portion 424 projecting toward the receiving space 48 from the inner face 422. The blocking portion 424 is formed into a wedge-shaped rib in this embodiment, and could be formed into anther configuration in other embodiment. The upper wall 42 defines a groove 420 communicating with the receiving space 48 and adjacent to the blocking portion 424. The groove 420 is adapted for providing a deformation space when the protecting means 4 accommodates the electrical connector 2, and is adapted for easing dropping the protecting means 4 off the mold in manufacture. The protecting means 4 further has a resilient beam 440 extending from the bottom wall 44 of the cap portion 41. The end portion of the resilient beam 440 is bent inwardly to form a bending portion 442.

In assembling of the electrical connector assembly 100, the cable is received in the hole 430 of the protecting means 4 firstly. The protecting means 4 together with the cable is assembled to the electrical connector 2. The insulative housing 20 is accommodated in the receiving space 48 of the protecting means 4, with the blocking portion 424 abutting against the top face 208 of the insulative housing 20. Referring to FIG. 5, in a first position, the blocking portion 424 is plunged in the notch 204 and confined in the notch 204. Referring to FIG. 6, along with the insertion of the insulative housing 20, the blocking portion 424 slides forwardly in the notch 204 till a second position. In a second position, the insulative housing 20 resists against the shoulder portion 49 of the protecting means 4, and the blocking portion 424 resists against the front face 2111 of the notch 204. The teeth 223 of the contact terminals 22 and the retention portion 212 clasp the cable. The distal end of the latch 206 is disposed beneath the resilient beam 440. The width of the resilient beam 440 is wider than the latch 206 to protect the latch 206 from being distorted. When the electrical connector 2 mates with the complementary connector, the resilient beam 440 is depressed to press the latch 206.

In another embodiment, the notch 204 could be defined in the protecting means 4, and the blocking portion 424 could be formed in the insulative housing 20.

The blocking portion 424 is confined in the notch 204 and permitted in a forward movement while the blocking portion 424 is not to have a movement along a direction perpendicular to the forward direction. No matter what material the protecting means 4 is made of, the protecting means 4 would latch with the insulative housing 20 reliably due to the engagement between the blocking portion 424 and the notch 204. Understandably, in the current embodiment during mating, the user may press the resilient beam 440 to deflect the latch 206 correspondingly and further cause the protecting means 4 to move forwardly relative to the housing 20 to the second position for precisely mating the connector 2 with the complementary (receptacle) connector. Anyhow, the protecting means 4 may backwardly move relative to the housing 20 to the first position once the connector is fully mated with the complementary connector and the user releases the resilient beam 440, due to the restoration force of the latch 206 and the wedged configuration of the blocking portion 424. In an alternate embodiment, the resilient beam 440 may define a slot to have the free end portion of the latch 206 extend therethrough so as to have the relative back-and-forth movement between the resilient beam 440 and the latch 206 more smooth.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector assembly for mating with a complementary connector and connecting with a cable, comprising:
an electrical connector comprising an insulative housing formed with a latch, and a plurality of contact terminals mounted in the insulative housing; and
a protecting means partially accommodating the insulative housing and formed with a resilient beam, said latch of the electrical connector disposed beneath the resilient beam,
one of the insulative housing and the protecting means being formed with a blocking portion, and the other one of the insulative housing and the protecting means defining a notch, said blocking portion being confined in the notch.

2. The electrical connector assembly as claimed in claim 1, wherein said notch is defined in the insulative housing of the electrical connector, and the blocking portion is formed on the protecting means.

3. The electrical connector assembly as claimed in claim 2, wherein said protecting means comprises a cap portion and a tail portion defining a hole, said cap portion having an upper wall and a bottom wall opposite to the upper wall, said blocking portion being formed on the upper wall and the resilient beam being formed on the bottom wall.

4. The electrical connector assembly as claimed in claim 3, wherein said blocking portion of the protecting means is formed into wedge-shaped rib projecting toward the notch from an inner face of the upper wall of the protecting means.

5. The electrical connector assembly as claimed in claim 3, wherein said protecting means defines a receiving space between the upper and bottom walls and communicating with the hole of the tail portion, and said upper wall of the protecting means defines a groove communicating with the receiving space and adjacent to the blocking portion.

6. The electrical connector assembly as claimed in claim 5, wherein said blocking portion is permitted a movement along a front-to-back direction between a first position and a second position.

7. The electrical connector assembly as claimed in claim 6, wherein said notch has a front face and a rear face, and said protecting means is formed with a shoulder portion in the receiving space, said blocking portion resisting against the front face of the notch and the insulative housing abutting against the shoulder portion of the protecting means in the second position.

8. The electrical connector assembly as claimed in claim 2, wherein said electrical connector comprises a retention portion disposed in the notch and then bent away from the notch for clasping the cable.

9. The electrical connector assembly as claimed in claim 8, wherein said notch defines a slit between the rear face of the notch and the retention portion.

10. The electrical connector assembly as claimed in claim 1, wherein said resilient beam of the protecting means has an end portion bent inwardly to form a bending portion for preventing the latch of the insulative housing from escaping.

11. An electrical plug connector for coupling to a complementary connector, comprising:
an insulative housing defining a front mating port;
a resilient latch providing upon one exterior face of the housing and defining a latching section on a front portion and a releasing section on a rear portion thereof;
a plurality of contacts disposed in the housing with contacting sections exposed in the mating port; and
a protecting device mounted upon the housing behind the resilient latch, said protecting device defining a resilient segment abutting against the releasing section of the resilient latch; wherein
the housing and the protecting device are configured with a space therebetween in a front-to-back direction to allow the protecting device to back and forth move relative to the housing in said front-to-back direction so as to facilitate operation of mating/un-mating when pressing the resilient segment of the protecting device against the resilient latch for deflecting the resilient latch.

12. The electrical plug connector as claimed in claim 11, wherein the protecting device shields at least a portion of a releasing section of the resilient latch.

13. The electrical plug connector as claimed in claim 11, wherein one of the housing and the protecting device defines a blocking portion and the other defines a notch corresponding to receive said blocking portion therein under condition that said blocking portion is moveable in the notch along the front-to-back direction.

14. The electrical plug connector as claimed in claim 13, wherein the blocking portion and the notch are located around another exterior face of the housing opposite to sad exterior face.

15. The electrical plug connector as claimed in claim 13, wherein the protecting device defines tendency to leave away from the housing due to at least either engagement between the releasing section of the resilient latch and the resilient segment of the protecting device, or a wedged structure formed on the blocking portion.

16. The electrical plug connector as claimed in claim 11, wherein said resilient segment is of a cantilevered manner under condition that a free end of said resilient segment essentially constantly engaged with a free end of the resilient section of the resilient latch.

17. An electrical plug connector for coupling to a complementary connector, comprising:
an insulative housing defining a front mating port;
a resilient latch providing upon one exterior face of the housing and defining a latching section on a front portion and a releasing section on a rear portion thereof;
a plurality of contacts disposed in the housing with contacting sections located in the mating port; and
a protecting device mounted upon the housing behind the resilient latch, said protecting device defining a resilient segment abutting against the releasing section of the resilient latch; wherein
one of the housing and the protecting device defines a blocking portion and the other defines a notch corresponding to receive said blocking portion therein under condition that the blocking portion and the notch are located around another exterior face of the housing opposite to sad exterior face.

18. The electrical plug connector as claimed in claim 17, wherein both said releasing section of the resilient latch and the resilient segment of the protecting device are of a cantilevered manner under condition that freed ends thereof are engaged with each other.

19. The electrical plug connector as claimed in claim 18, wherein the free end of the resilient segment of the protecting device covers the free end of the releasing section of the resilient latch.

20. The electrical plug connector as claimed in claim 19, wherein the releasing section of the resilient latch and the resilient segment of the protecting device extend along directions opposite to each other.
